(19) United States
(12) Patent Application Publication
(10) Pub. No.: US 2019/0142030 A1
(43) Pub. Date: May 16, 2019

(54) HAY TENDERIZER

(71) Applicant: Mike Gobble, Cleveland, TN (US)

(72) Inventor: Mike Gobble, Cleveland, TN (US)

(21) Appl. No.: 15/810,072

(22) Filed: Nov. 12, 2017

(51) Int. Cl. A23K 10/30

(52) U.S. Cl. CPC A23K 10/30; A23K 30/10

(57) ABSTRACT

An animal feed tenderizing system that includes: a conveyor trough; a press wheel, where the press wheel is positioned within the conveyor trough and adapted to roll over animal feed; a motor, wherein the motor is engaged with the press wheel and provides a means to rotate the press wheel; and a wheel base, where the wheel base supports the trough. The press wheel is preferably made of steel. The trough is adapted to receive animal feed, wherein the animal feed is hay. The means to rotate the press wheel may include a pulley system attached to a motor, where the motor is a hydraulic motor. The press wheel is adapted to compress animal feed to enable rehydration of the animal feed.

### CROSS REFERENCE TO OTHER APPLICATIONS

This application claims priority to U.S. Provisional Application Ser. No. 62/449,213 filed on Jan. 23, 2017.

### BACKGROUND OF THE INVENTION

### Field of Invention

The present invention relates to a mechanism used to rehydrate hay.

### Description of Related Art

Many farmers use various types of animal feeds for livestock. One of the principal forms of animal feed is hay which is widely used and includes a number of dry plants, legumes and grasses. Normally the hay is delivered to a farmer in a dry form although animals may consume the dry hay it takes longer for the nutrients to absorb through the digestive process. As a result it would be advantageous to rehydrate the dry hay to improve digestion for the livestock. Wet hay also activates more of the nutrients, so the livestock should become healthier.

### SUMMARY OF THE INVENTION

The present invention relates to an animal feed tenderizing system that includes: a conveyor trough; a press wheel, where the press wheel is positioned within the conveyor trough and adapted to roll over animal feed; a motor, wherein the motor is engaged with the press wheel and provides a means to rotate the press wheel; and a wheel base, where the wheel base supports the trough. The press wheel is preferably made of steel. The trough is adapted to receive animal feed, wherein the animal feed is hay. The means to rotate the press wheel may include a pulley system attached to a motor, where the motor is a hydraulic motor. The press wheel is adapted to compress animal feed to enable rehydration of the animal feed.

### BRIEF DESCRIPTION OF DRAWINGS

FIG. 1 takes a device for tenderizing or hydrating hay in accordance with the present invention.

### DETAILED DESCRIPTION

The present invention relates to a device used to hydrate and tenderize hay through a mechanical process. The hay is placed on a steel trough that includes a steel press wheel. As the hay passes under the wheel the wheel compresses the hay and helps to hydrate the hay as it is moistened on the trough. This system provides a more suitable feed for livestock. The steel wheel applies pressure to the hay and is turned by a hydraulic motor. Preferably the mechanism is placed on a hitch trailer so the device is portable.

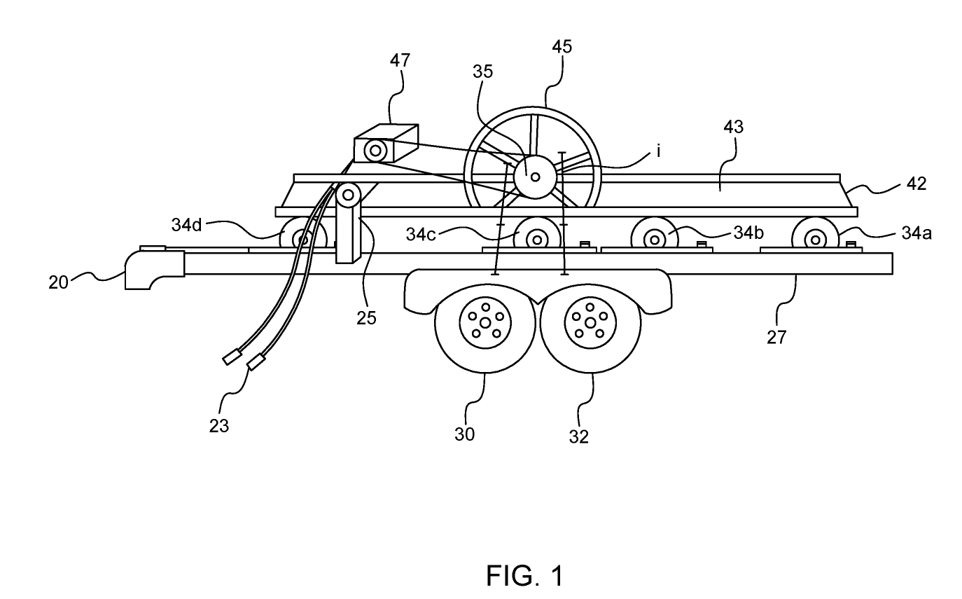

In reference FIG. 1, a hay processing device in accordance with the present invention is depicted. The hay processing device includes a steel press Wheel 45, where the steel press Wheel 45 is aligned on a Trough 43. Animal feed in the form of hay is placed on the Trough 43 at an entry End 42. Once the hay is on the trough, the steel press Wheel 45 is activated through and moves through a pulley System 35 attached to a Motor 47. The Motor 47 is preferably a hydraulic motor as shown with hydraulic Lines 23 providing hydraulic power to the Motor 47. The wheel 45 moves the feed under the wheel 45 on the Trough 43 and pivots at a pivot Point 25 therefore compressing the hay as it moves under the Wheel 45. As the hay is compressed it is rehydrated therefore creating a more active food source for the livestock. The Trough 43 is mounted on a wheelbase as shown with Wheels 34a, 34b, 34c, 34d. The entire feed processing device may be maneuvered on a hitch Trailer 27 as shown. The hitch trailer 27 further includes Wheels 30, 32 with a Hitch 20. This makes the feed processing device mobile and portable for the user.

The hay processing device creates a conveyer system and it hydrates dry hay through the steel press wheel at a steady and controlled pace. The wheel essentially crushes the hay through a back and forth movement therefore tenderizing dry hay feed. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. An animal feed tenderizing system comprising:
a. a conveyor trough;
b. a press wheel, where the press wheel is positioned within the conveyor trough and adapted to roll over animal feed;
c. a motor, wherein the motor is engaged with the press wheel and provides a means to rotate the press wheel; and
d. a wheel base, where the wheel base supports the trough.

2. The animal feed tenderizing system according to claim 1, where the press wheel is made of steel.

3. The animal feed tenderizing system according to claim 1, wherein the trough is adapted to receive animal feed.

4. The animal feed tenderizing system according to claim 3, wherein the animal feed is hay.

5. The animal feed tenderizing system according to claim 1, where the means to rotate the press wheel includes a pulley system attached to a motor.

6. The animal feed tenderizing system according to claim 5, where the motor is a hydraulic motor.

7. The animal feed tenderizing system according to claim 1, where the press wheel is adapted to compress animal feed to enable rehydration of the animal feed.
